(19) United States
(12) Patent Application Publication
(10) Pub. No.: US 2025/0319701 A1
(43) Pub. Date: Oct. 16, 2025

(54) LIQUID DISCHARGING APPARATUS

(71) Applicant: BROTHER KOGYO KABUSHIKI KAISHA, Nagoya (JP)

(72) Inventors: Haruhisa SHIRAI, Kasugai (JP); Kazuma KOBAYASHI, Nagoya (JP); Kazushige SAIGUSA, Nagoya (JP); Fumiya NAKAMURA, Nagoya (JP); Shohei ICHIKAWA, Niwa (JP); Asami HASHIMOTO, Okazaki (JP); Masako KAWAGOE, Nagoya (JP)

(73) Assignee: BROTHER KOGYO KABUSHIKI KAISHA, Nagoya (JP)

(21) Appl. No.: 19/252,369

(22) Filed: Jun. 27, 2025

Related U.S. Application Data
(63) Continuation of application No. 18/191,993, filed on Mar. 29, 2023.

(30) Foreign Application Priority Data
Apr. 1, 2022 (JP) 2022-062149

(51) Int. Cl. B41J 2/17; B41J 29/02

(52) U.S. Cl. CPC B41J 2/1721; B41J 29/02; B41J 2/1728

(57) ABSTRACT

A liquid discharging apparatus, having a housing, a liquid discharging head, and a waste liquid tank for storing waste liquid, is provided. The waste liquid tank is demountably mounted in the housing through an opening formed on a sideward face on one side in a widthwise direction, which is parallel to a nozzle surface of the liquid discharging head and intersects orthogonally with a conveying direction to convey a sheet. The opening is formed between a first position and a second position apart from the first position in the conveying direction. The waste liquid tank is mounted in the housing in an arrangement such that a length in the widthwise direction is shorter than a length in the conveying direction. The waste liquid tank is mountable in and demountable from the housing along the widthwise direction of the waste liquid tank.

### REFERENCE TO RELATED APPLICATIONS

This is a Continuation application of U.S. patent application Ser. No. 18/191,993, filed on Mar. 29, 2023, which claims priority from Japanese Patent Application No. 2022-062149 filed on Apr. 1, 2022. The entire content of the priority application is incorporated herein by reference.

### BACKGROUND ART

A liquid discharging apparatus that may discharge liquid from a liquid discharging head to print an image on a sheet is known. The liquid discharging apparatus may have a waste liquid tank to collect waste liquid discharged from the liquid discharging head. The waste liquid tank may be removably mounted in a corner area in a housing of the liquid discharging apparatus.

### DESCRIPTION

Generally, in liquid discharging apparatuses, enhancing members such as ribs and beams to enhance strength of the housing may be arranged in corner areas. Therefore, if the removable waste liquid tank is located in the corner area of the housing, the strength of the housing may be lowered.

The present disclosure is advantageous in that a liquid discharging apparatus, in which an exchangeable waste liquid tank is arranged, and in which strength of a housing may be secured, is provided.

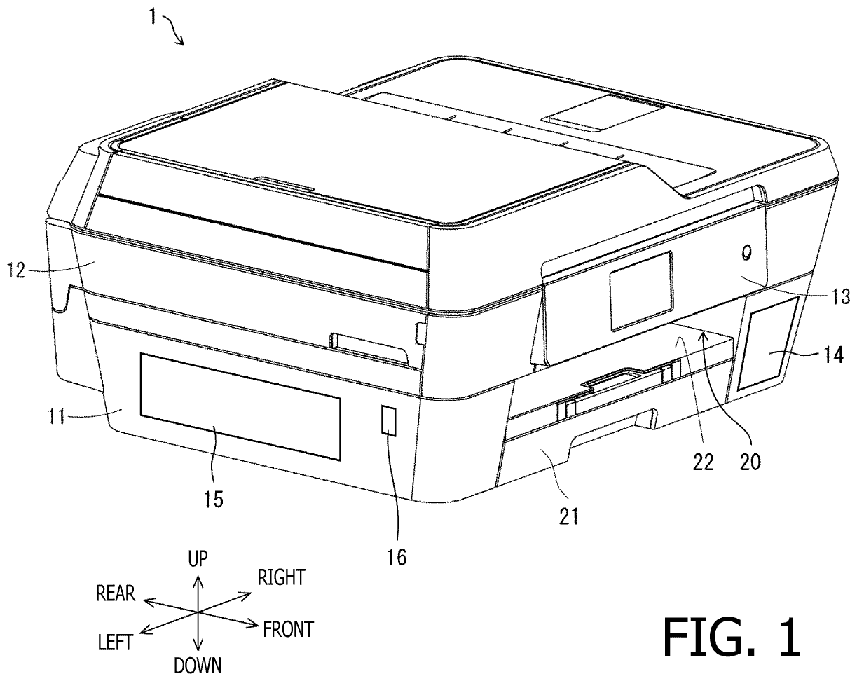

FIG. 1 is a perspective exterior view of an inkjet printer.

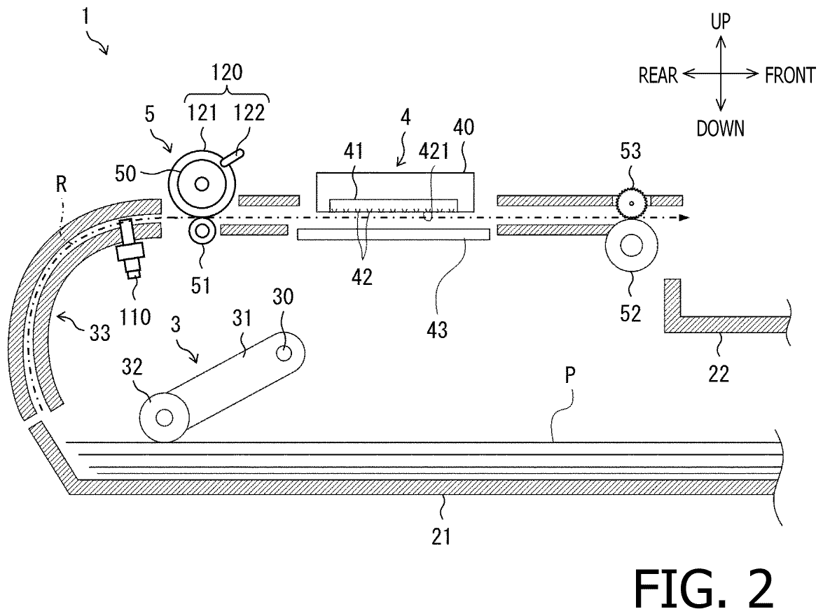

FIG. 2 is a cross-sectional view to illustrate an inner structure of the inkjet printer.

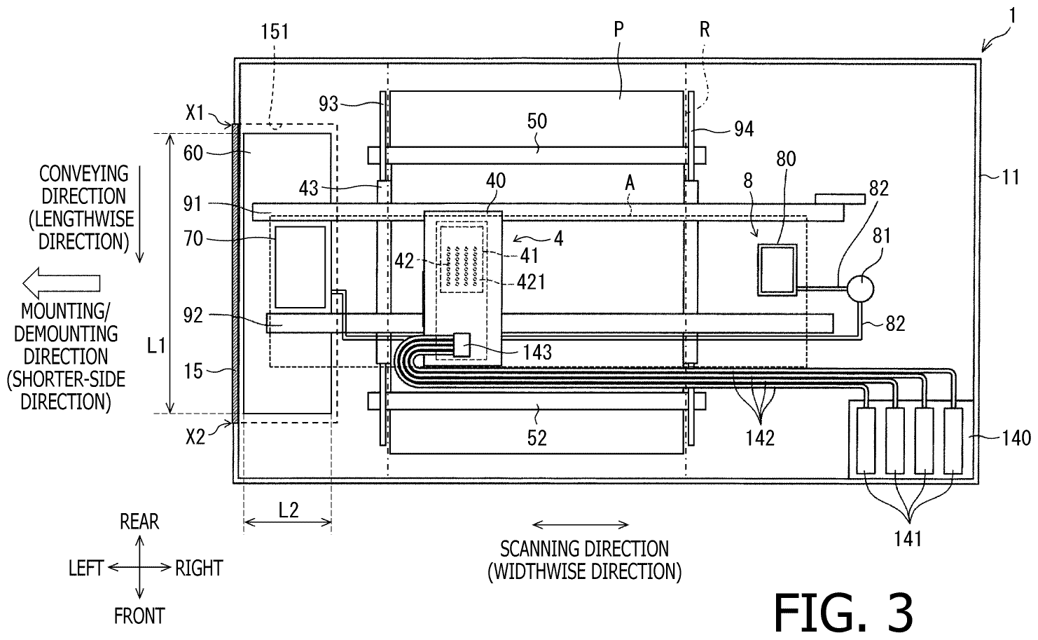

FIG. 3 is a plan view of an area in the inkjet printer including a recorder viewed from an upper side.

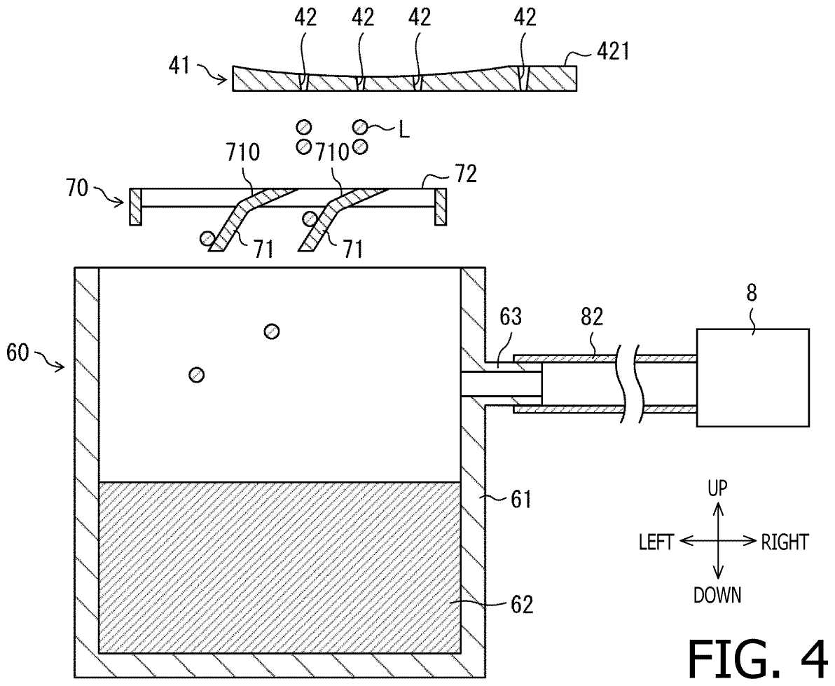

FIG. 4 is a cross-sectional view of a waste liquid tank and a flushing unit in the inkjet printer.

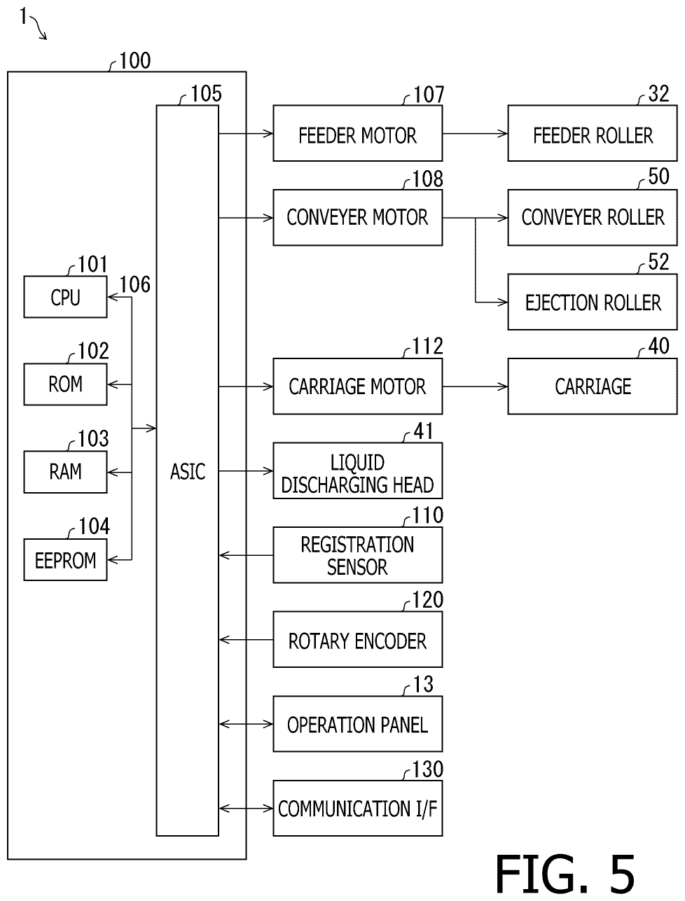

FIG. 5 is a block diagram to illustrate an electric configuration of the inkjet printer.

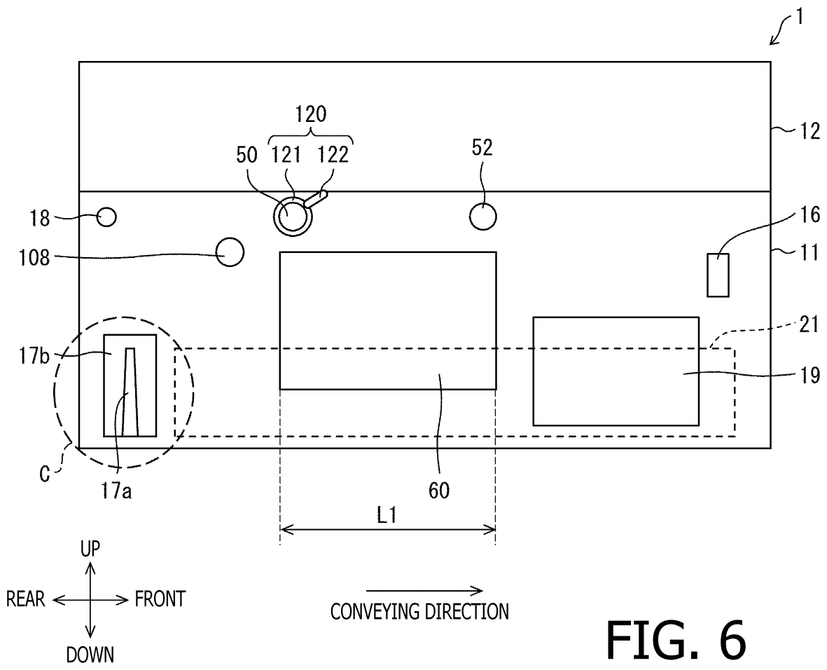

FIG. 6 is a sideward view of the inkjet printer viewed from left.

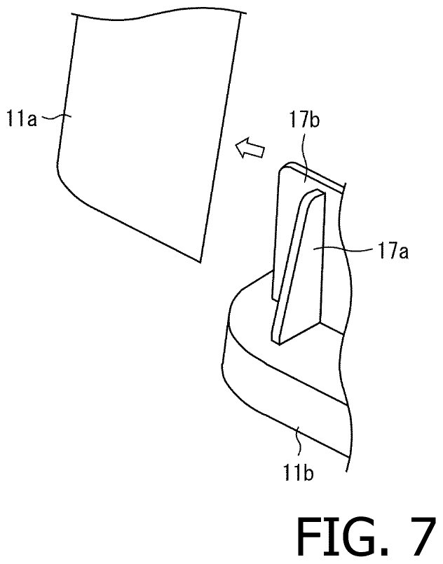

FIG. 7 is a perspective view of ribs and a peripheral area in the inkjet printer.

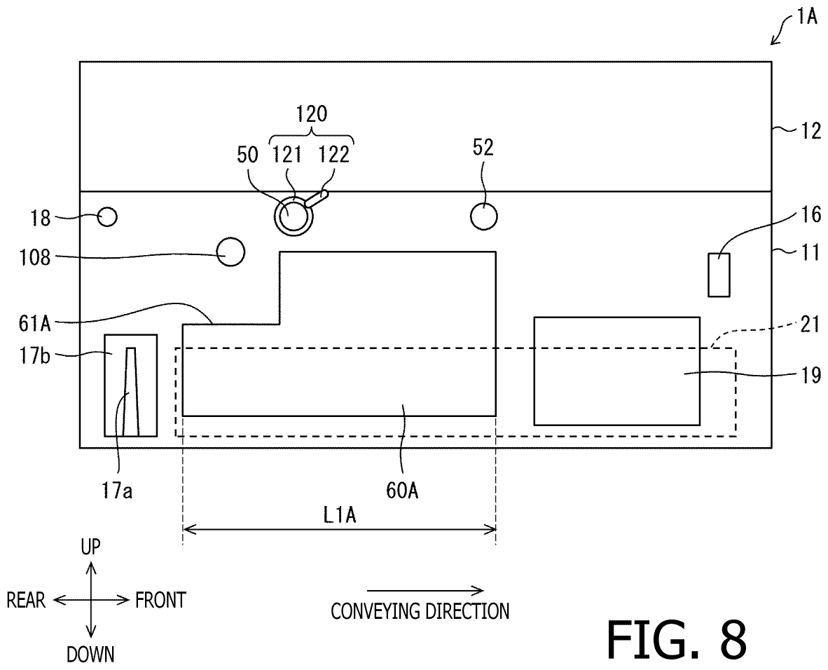

FIG. 8 is a sideward view of an inkjet printer viewed from left.

### FIRST EMBODIMENT

An inkjet printer 1 according to a first embodiment of the present disclosure will be described below with reference to FIGS. 1-6.

### [Overall Configuration of Inkjet Printer]

FIG. 1 is a perspective exterior view of the inkjet printer 1. As shown in FIG. 1, the inkjet printer 1 has a housing 11, a reader 12, and an operation panel 13. The housing 11 is substantially in a form of a rectangular box.

The reader 12 is located in an upper area in the housing 11 and may read an image recorded on, for example, a sheet P. The reader 12 is pivotable with respect to the housing 11 through a hinge 18 (see FIG. 6) around a pivot axis.

The operation panel 13 is arranged on a front face of the housing 11 and has buttons and a display, e.g., a liquid crystal display. In the following description, vertical (up-down), widthwise (right-left), and front-rear directions in the inkjet printer 1 are defined with reference to an orientation of the inkjet printer 1 in a usable condition as shown in FIG. 1 and as indicated by arrows in FIG. 1.

The inkjet printer 1 may discharge liquid. In particular, the inkjet printer 1 has an inkjet-styled printing function for printing an image on the sheet P by discharging ink L according to print data provided in a print job. The image to be printed on the sheet P may either be a multicolor image or a monochrome image. The sheet P may be, for example, A4-sized regular printing paper. Optionally, the sheet P may be, for another example, cardboard or thinner paper.

On the front face of the inkjet printer 1, an opening 20 is formed. Through the opening 20, a feeder tray 21 and an ejection tray 22 are detachably attached to the housing 11. The feeder tray 21 is a container to store sheets P and is open upward. The ejection tray 22 is located above the feeder tray 21, and the sheets P with images printed thereon may be ejected at the ejection tray 22.

On the front face of the housing 11, further, a cover 14 is arranged. The cover 14 is pivotable with respect to the housing 11. On an inner side of the cover 14, ink cartridges 141 accommodated in a cartridge case 140 are attached (see FIG. 3).

On a leftward face of the housing 11, a waste liquid tank cover 15 is arranged. The waste liquid tank cover 15 is openable/closable with respect to the housing 11. The waste liquid tank cover 15 being open allows the waste liquid tank 60 to be mounted in and demounted from the housing 11.

Meanwhile, the waste liquid tank cover 15 may not necessarily be pivotable to open and close the area accommodating the waste liquid tank 60. For example, a waste liquid tank unit, which consists of the waste liquid tank 60 and a tank retainer having the cover to retain the waste liquid tank 60, may be mountable in the housing 11. In this arrangement, when the waste liquid tank unit is demounted from the housing 11, an opening 151 (see FIG. 3) having a form that corresponds to a form of the waste liquid tank unit may be exposed on the leftward face of the housing 11, and when the waste liquid tank unit is mounted in the housing, the cover attached to the waste liquid tank unit may close the opening 151.

Moreover, at a frontward position on the leftward face of the housing 11, a port 16, to which an external device (not shown) is connectable, is located. The external device may be, for example, a USB memory, a PC, etc.

### [Internal Configuration of Inkjet Printer]

Next, an internal configuration of the inkjet printer 1 will be described with reference to FIGS. 2-3. FIG. 2 is a cross-sectional view to illustrate the inner structure of the inkjet printer 1. As shown in FIG. 2, the inkjet printer 1 includes a feeder 3, a conveyer path R, a recorder 4, and a conveyer 5.

The feeder 3 includes a shaft 30, a feeder arm 31, and a feeder roller 32. The feeder roller 32 may feed the sheets P stored in the feeder tray 21 to the conveyer path R. The feeder roller 32 is located at a tip end of the feeder arm 31 and is supported rotatably by the feeder arm 31. The feeder arm 31 is pivotably supported by the shaft 30, which is supported by a frame of the inkjet printer 1.

The conveyer path R extends upward from a rear end of the feeder tray 21, curving frontward in an area delimited by a guide member 33, through the area in which the recorder 4 is located, to the ejection tray 22. The feeder roller 32 may, when a feeder motor 107 (see FIG. 5) is activated, rotate and pick up the sheets P from the feeder tray 21 one by one. The sheets P picked up from the feeder tray 21 may be conveyed along the conveyer path R and conveyed to the recorder 4.

The recorder 4 is located above the feeder 3 and may record images on the sheets P. The recorder 4 includes a carriage 40, a liquid discharging head 41, a plurality of nozzles 42, and a platen 43. The carriage 40 may, when a driving force from a carriage motor 112 (see FIG. 5) is transmitted thereto, move back and forth in a scanning direction which coincides with the widthwise direction.

The liquid discharging head 41 is mounted on the carriage 40. The plurality of nozzles 42 are formed on a lower face, i.e., a nozzle surface 421, of the liquid discharging head 41. The nozzle surface 421 spreads in the widthwise direction and in the front-rear direction. The plurality of nozzles 42 are arrayed in lines along the front-rear direction to form nozzle lines, and four (4) nozzle lines are formed on the nozzle surface 421 to align in the widthwise direction.

The nozzles 42 forming a first one of the nozzle lines, a second one of the nozzle lines, a third one of the nozzle lines, and a fourth one of the nozzle lines from right to left, may discharge inks L in colors of yellow (Y), cyan (C), magenta (M), and black (K), respectively. However, the aligning order of the nozzle lines may not necessarily be limited but may be changed optionally on a model basis.

The liquid discharging head 41 may discharge droplets of inks L through the nozzles 42 by causing vibrating devices such as piezo elements to vibrate. The platen 43 is located below the liquid discharging head 41 and extends throughout or over the entire length of the sheet P in the widthwise direction. The platen 43 may support the sheet P from below during a recording process.

The platen 43 is a substantially rectangular plate, on which the sheet P may be placed. While the carriage 40 moves in the widthwise direction over the sheet P supported by the platen 43, the liquid discharging head 41 may discharge the droplets of inks L selectively from the nozzles 42 to record the image on the sheet P.

The conveyer 5 includes a conveyer roller 50 and an ejection roller 52, which are located on one side and the other side, respectively, of the recorder 4 in the front-rear direction. The conveyer roller 50 may be driven by a conveyer motor 108 to rotate.

At a position below the conveyer roller 50, a pinch roller 51 is arranged to face the conveyer roller 50. The pinch roller 51 may rotate along with the rotation of the conveyer roller 50. With the rotation of the conveyer roller 50 and the pinch roller 51, the sheet P nipped between the conveyer roller 50 and the pinch roller 51 may be conveyed along the conveyer path R to the recorder 4.

The ejection roller 52 is located on a downstream side of the recorder 4 in a conveying direction to convey the sheet P in the conveyer path R. At a position above the ejection roller 52, a spur roller 53 is arranged to face the ejection roller 52. The ejection roller 52 may be driven by the conveyer motor 108 to rotate. The spur roller 53 may rotate along with the rotation of the ejection roller 52. With the rotation of the ejection roller 52 and the spur roller 53, the sheet P nipped between the ejection roller 52 and the spur roller 53 may be ejected from the conveyer path R to rest at the ejection tray 22.

On an upstream side of the conveyer roller 50 in the conveyer path R, a registration sensor 110 is located. The registration sensor 110 may detect a front end and a rear end of the sheet P passing through a contact position, where the sheet P contacts the conveyer roller 50. The registration sensor 110 may be, for example, a sensor with an actuator that may swing when the sheet P contacts the actuator, or an optical sensor.

The registration sensor 110 may output ON signals while the sheet P is present at the position of the registration sensor 110 and OFF signals while the sheet P is absent at the position of the registration sensor 110. In other words, in a period between a point, at which the front end of the sheet P reaches the position of the registration sensor 110, and a point, at which the rear end of the sheet P leaves the position of the registration sensor 110, the registration sensor 110 may continuously output the ON signals. For the remainder of time, the registration sensor 110 may output the OFF signals. The signals from the registration sensor 110 may be output to a controller 100 (see FIG. 5).

On the conveyer roller 50, a rotary encoder 120 to detect rotation of the conveyer roller 50 is arranged. The rotary encoder 120 may output pulse signals corresponding to a rotation amount of the conveyer roller 50 to the controller 100. The rotary encoder 120 includes an encoder disk 121 and an optical sensor 122. The encoder disk 121 may rotate along with the conveyer roller 50. The optical sensor 122 may read the rotating encoder disk 121, generate pulse signals according to the rotation amount, and output the generated pulse signals to the controller 100.

FIG. 3 is a plan view of an area in the inkjet printer 1 including the recorder 4 viewed from an upper side. As shown in FIG. 3, the recorder 4 is connected with the ink cartridges 141 through supplying tubes 142, and the inks L in the ink cartridges 141 may be supplied to the recorder 4 through the supplying tubes 142. The inks L supplied from the ink cartridges 141 may be stored in a buffer tank (not shown) in the recorder 4. Compartments (not shown) inside the buffer tank are continuous with the nozzles 42.

The buffer tank has a tube joint 143, which is formed integrally with the buffer tank. To the tube joint 143, ends of the supplying tubes 142 are detachably attached. The other ends of the supplying tubes 142 are connected to the ink cartridges 141.

As shown in FIG. 3, guide rails 91, 92 extending in parallel with the scanning direction, e.g., the widthwise direction as shown in FIG. 3, are arranged above the platen 43. The carriage 40 is supported by the guide rails 91, 92. The carriage 40 may move along the guide rails 91, 92 in the scanning direction in an area where the carriage 40 faces the platen 43. Optionally, a single guide rail rather than two guide rails 91, 92 may be provided.

At positions below the guide rails 91, 92, two supporting frames 93, 94 are arranged. The supporting frames 93, 94 extend in the vertical direction in the housing 11 and are spaced apart from each other in the scanning direction. The supporting frame 93 supports leftward positions of the guide rails 91, 92 and leftward positions of the conveyer roller 50 and the ejection roller 52. The supporting frame 94 supports rightward positions of the guide rails 91, 92 and rightward positions of the conveyer roller 50 and the ejection roller 52. Optionally, a single supporting frame rather than two supporting frames 93, 94 may be provided.

The carriage 40 is connected with a driving belt (not shown). The driving belt is an endless belt strained around two pulleys (not shown). One of the pulleys is coupled to a carriage motor 112 (see FIG. 5). As the carriage motor 112 rotates in one way or the other way, the pulley coupled to the carriage motor 112 may rotate, and the driving belt may circulate. Thereby, the carriage 40 connected with the driving belt may move to reciprocate in the scanning direction. Moreover, the recorder 4 mounted on the carriage 40 may move to reciprocate in the scanning direction.

### [Configuration of Maintenance Unit]

As shown in FIG. 3, the inkjet printer 1 has a maintenance unit 8 at a position rightward with respect to the platen 43. The maintenance unit 8 includes a cap 80, a pump 81, and a waste liquid tube 82. The maintenance unit 8 may perform a maintenance process on the liquid discharging head 41. In particular, the maintenance unit 8 may perform a purging action to suction the waste liquid such as the inks L from the nozzles 42.

The cap 80 may be formed of, for example, rubber. The cap 80 is located at a position to face the liquid discharging head 41 to receive the waste liquid expelled from the nozzles 42 during the maintenance process. The pump 81 may be driven by a motor (not shown) to suction the waste liquid including the inks L from the nozzles 42.

The waste liquid tube 82 extends from the cap 80 through the pump 81 to the waste liquid tank 60. The waste liquid suctioned by the pump 81 may be transported from the cap 80 through the waste liquid tube 82 to the waste liquid tank 60.

### [Configuration of Flushing Unit]

FIG. 4 is a cross-sectional view of the waste liquid tank 60 and a flushing unit 70 in the inkjet printer 1. The flushing unit 70 has, as shown in FIG. 4, a waste liquid guide 71 and a guide retainer frame 72. The flushing unit 70 may prevent the inks L discharged from the nozzles 42 from scattering in mist during a flushing process and guide the inks L to the waste liquid tank 60.

The flushing process is an action to operate the liquid discharging head 41, while the carriage 40 is located at a position to face the flushing unit 70, to discharge the inks L through the nozzles 42 at the waste liquid guide 71, rather than at the sheet P.

For preventing the inks L discharged in the flushing process from scattering in mist, the waste liquid guide 71 has a slant surface 710 extending in a direction to intersect with the vertical direction being a direction to discharge the inks L from the nozzles 42. The inks L discharged from the liquid discharging head 41 in the flushing process may land on the slant surface 710 of the waste liquid guide 71 and may be guided along the slant surface 710 to a waste liquid absorber 62 located inside the waste liquid tank 60. The waste liquid guide 71 may include one or more pieces of waste liquid guide 71.

The guide retainer frame 72 retains the waste liquid guide 71. The guide retainer frame 72 is a frame, to which the waste liquid guide 71 is fixed, and has a substantially rectangular form in a top plan view. The waste liquid guide 71 is fixed to the waste liquid tank 60 by, for example, fastening the guide retainer frame 72 to the housing 11 with screws.

### [Electrical Configuration of Inkjet Printer 1]

FIG. 5 is a block diagram to illustrate an electric configuration of the inkjet printer 1. As shown in FIG. 5, the inkjet printer 1 has the controller 100, the feeder motor 107, the conveyer motor 108, the carriage motor 112, and a communication interface (I/F) 3.

The controller 100 includes a central processing unit (CPU) 101, a read-only memory (ROM) 102, a random access memory (RAM) 103, an EEPROM 104, and ASIC 105, which are connected with one another through an internal bus. “EEPROM” is a registered trademark of NEC Corporation.

The ROM 102 may store programs that may be executed by the CPU 101 to control actions in the inkjet printer 1. The RAM 103 may be used as a storage area, in which data and signals to be used in the programs by the CPU 101 may be stored, and a work area for processing data.

The EEPROM 104 may store configuration information that may be maintained when power to the inkjet printer 1 is on and off. The controller 100 may control behaviors of the feeder motor 107, the conveyer motor 108, the carriage motor 112, and the liquid discharging head 41 according to the programs called from the ROM 102.

The ASIC 105 is connected with the feeder motor 107, the conveyer motor 108, the carriage motor 112, the liquid discharging head 41, the registration sensor 110, the rotary encoder 120, the operation panel 13, and a communication I/F 130.

The ASIC 105 may supply driving currents to the feeder motor 107, the conveyer motor 108, and the carriage motor 112. The controller 100 may control rotations of the feeder motor 107, the conveyer motor 108, and the carriage motor 112 according to, for example, pulse-width modulation (PWM) control.

The controller 100 may apply driving voltages to the vibrating devices in the liquid discharging head 41 to cause the ink droplets to be discharged from the nozzles 42. The controller 100 may detect the sheet P passing through the contact position, where the sheet P contacts the conveyer roller 50, based on the detection signals output from the registration sensor 110. The controller 100 may detect the rotation amount of the conveyer roller 50 based on the pulse signal output from the rotary encoder 120.

The communication I/F enables communication between the inkjet printer 1 and an external device, such as a PC, which is connected to a network such as LAN, and in which a driver program for the inkjet printer 1 is installed. The inkjet printer 1 may receive print jobs through the communication I/F.

For recording an image on the sheet P, the controller 100 may control the conveyer 5 to convey the sheet P in the conveying direction, control the carriage 40 with the liquid discharging head 41 to move in the scanning direction, and control the liquid discharging head 41 mounted on the carriage 40 to discharge the inks L.

### [Configuration of Waste Liquid Tank]

Next, the waste liquid tank 60 will be described with reference to FIGS. 3-4 and 6. FIG. 6 is a sideward view of the inkjet printer 1 viewed from left. As shown in FIG. 4, the waste liquid tank 60 has a waste liquid case 61, a waste liquid absorber 62, and a port 63 and may store the waste liquid. The waste liquid may include the inks L discharged from the nozzles 42 and liquid other than the inks L, such as cleaning liquid and filler liquid for shipment.

The waste liquid case 61 may be made of, for example, synthetic resin. The waste liquid case 61 has an opening at an upper side thereof and has a substantially rectangular boxed shape in a top plan view. The waste liquid absorber 62 is located inside the waste liquid case 61. The waste liquid absorber 62 may be made of, for example, unwoven fabric, sponge, or cotton that may absorb the waste liquid. Thus, with the waste liquid absorber 62 absorbing the waste liquid, the waste liquid discharged from the nozzles 42 may be stored in the waste liquid tank 60.

Through the port 63, the waste liquid tube 82 is connected to the waste liquid case 61. The port 63 may be formed on, for example, a rightward face of the waste liquid case 61. Around an outer circumference of the port 63, an inner circumference of the waste liquid tube 82 may be fitted, and thereby space inside the waste liquid case 61 and space inside the waste liquid tube 82 may communicate. Accordingly, in the maintenance process, the waste liquid ejected from the maintenance unit 8 may be stored in the waste liquid tank 60.

The waste liquid tank 60 is located to be lower than the flushing unit 70. During the flushing process described above, the waste liquid expelled from the nozzles 42 may be guided to the waste liquid guide 71 and stored in the waste liquid tank 60. The port 63 of the waste liquid tank 60 may be, but not necessarily, formed on, for example, the rightward face of the waste liquid case 61 as shown in FIG. 3. Optionally, for another example, the port 63 may be formed on a front face or a leftward face of the waste liquid case 61.

The waste liquid tank 60 is a tank having a form of, for example, rectangular box. A length L2 of the waste liquid tank 60 in the widthwise direction is shorter than a length L1 of the waste liquid tank 60 in the conveying direction. The length L1 of the waste liquid tank 60 in the conveying direction may be, for example, longer than a length of the carriage 40 in the conveying direction and is longer than a distance between the guide rail 91 and the guide rail 92. Moreover, the length L1 of the waste liquid tank 60 in the conveying direction may be substantially equal to a distance between the conveyer roller 50 and the ejection roller 52.

The waste liquid tank 60 is mountable in and demountable from the housing 11 along the widthwise direction through the opening 151 formed on the leftward face of the housing 11. In other words, the waste liquid tank 60 mountable in the housing 11 is demountable along the scanning direction as indicated by an arrow in FIG. 3 through the leftward face of the housing 11. The form of the waste liquid tank 60 may not necessarily be limited to the rectangular box but may optionally be, for example, a polygonal box or a cylindrical container.

The opening 151 is formed between a first position X1, which is on the leftward face of the housing 11, and a second position X2, which is apart from the first position X1 in the conveying direction, i.e., in the front-rear direction, on the leftward face of the housing 11. A distance between the first position X1 and the second position X2 in the conveying direction is longer than the length L1 of the waste liquid tank 60 in the conveying direction, i.e., a lengthwise direction.

The waste liquid tank 60 is located on an outer side with respect to the supporting frame 93 in the widthwise direction. The waste liquid tank 60 and the supporting frame 93 are in positions to overlap each other in the widthwise direction in a plan view from an upper side of the housing 11. In this arrangement, a dimension of the inkjet printer 1 in the direction of height may be reduced.

As shown in FIG. 3, in the top plan view, the waste liquid tank 60 straddles an area inside a movable range A of the carriage 40 and an area outside the movable range A of the carriage 40. This arrangement may allow dimensions of the waste liquid tank 60 in the front-rear direction and the widthwise direction, i.e., a bottom area, to be increased, and a capacity of the waste liquid tank 60 may be secured.

Moreover, as shown in FIG. 6, the waste liquid tank 60 is arranged at a position to at least partly overlap the feeder tray 21 in a side view from the left. In other words, the waste liquid tank 60 is located to align with the feeder tray 21 side by side in the scanning direction.

Moreover, the waste liquid tank 60 is arranged to overlap the guide rails 91, 92 in a view from the upper side of the housing 11. In particular, the waste liquid tank 60 is located below the guide rails 91, 92. In this arrangement, the inkjet printer 1 may be downsized in the widthwise direction.

Moreover, as shown in FIG. 3, the waste liquid tank 60 is arranged to overlap the conveyer roller 50 and the ejection roller 52 in the plan view from the upper side of the housing 11. In particular, as shown in FIG. 6, the waste liquid tank 60 is located below both of the conveyer roller 50 and the ejection roller 52.

Moreover, the waste liquid tank 60 is located below the rotary encoder 120. In the arrangement where the waste liquid tank 60 is located in the space below the conveyer roller 50, the ejection roller 52, and the rotary encoder 120, the inkjet printer 1 may be downsized in the scanning direction, i.e., in the widthwise direction.

### [Peripheral Components of Waste Liquid Tank]

As shown in FIG. 6, on an upstream side from the waste liquid tank 60 in the conveying direction, i.e., rearward with respect to the waste liquid tank 60, at a position higher than the conveyer motor 108, the hinge 18 is arranged. The hinge 18 may be subject to a load of the reader 12; therefore, it is preferable that an enhancing member is arranged below the hinge 18. In the present embodiment, a plurality of ribs 17a, 17b as the enhancing member are arranged below the hinge 18.

FIG. 7 is a perspective view of an area C (see FIG. 6) including the ribs 17a, 17b in the inkjet printer 1. As shown in FIG. 7, the housing 11 has a cover member 11a, which forms an exterior covering of the inkjet printer 1, and a resin member 11b, which forms a bottom of the inkjet printer 1. The rib 17b extends upward from an upper surface of the resin member 11b. The rib 17a is attached to the rib 17b and extends upward from the upper surface of the resin member 11b.

With the ribs 17a, 17b and the hinge 18 arranged in the area rearward with respect to the waste liquid tank 60, the rearward area with respect to the waste liquid tank 60 in the inkjet printer 1 may be used efficiently. Optionally, the ribs 17a, 17b may be arranged on a downstream side of the waste liquid tank 60 in the conveying direction, i.e., on a frontward side with respect to the waste liquid tank 60. Further, optionally, ribs may be arranged on an inner surface of the cover member 11a. Moreover, the enhancing member may include wall(s) which is not shown in the drawings.

Moreover, on the upstream side with respect to the waste liquid tank 60 in the conveying direction, i.e., rearward with respect to the waste liquid tank 60, the conveyer motor 108 is arranged. While the conveyer motor 108 is located in the rearward area from the waste liquid tank 60 in the conveying direction, the mounting/demounting direction of the waste liquid tank 60 equates to the widthwise direction of the housing 11, i.e., a direction of shorter side of the waste liquid tank 60. Therefore, the conveyer motor 108 may not interfere with the waste liquid tank 60 being exchanged with another waste liquid tank 60. Thus, the rearward area with respect to the waste liquid tank 60 may be used efficiently.

Meanwhile, on the downstream side of the waste liquid tank 60 in the conveying direction, the port 16, to which an external device such as a USB connector and a LAN cable may be connected, is arranged. While the port 16 is located on the downstream side of the waste liquid tank 60 in the conveying direction, electrical leakage due to the waste liquid leaked from the waste liquid tank 60 and flowing toward the port 16 may be prevented. Meanwhile, optionally, the port 16 may be located on the upstream side of the waste liquid tank 60 in the conveying direction.

Moreover, on the downstream side of the waste liquid tank 60 in the conveying direction, a power board 19 in a form of a rectangular plate is arranged. The power board 19 may supply power to the inkjet printer 1. With the power board 19 arranged at the position on the downstream side of the waste liquid tank 60 in the conveying direction, the area on the downstream side of the waste liquid tank 60 in the conveying direction, i.e., the frontward area with respect to the waste liquid tank 60, may be used efficiently. Meanwhile, optionally, the power board 19 may be located on the rearward side of the waste liquid tank 60. Moreover, the exterior form of the power board 19 may not necessarily be limited to the rectangle but may be, for example, in an L form.

### [Benefits by First Embodiment]

According to the inkjet printer 1 being the first embodiment of the present disclosure, as shown in FIGS. 3 and 6, the waste liquid tank 60 is demountably mounted in the housing 11 through the opening 151, which is formed on the leftward face of the housing 11 between the first position X1 and the second position X2. Therefore, by arranging the enhancing member, such as the ribs 17a, 17b, in the corner area in the housing 11, the strength of the housing 11 may be secured.

Moreover, as shown in FIG. 3, when the waste liquid tank 60 is mounted in or demounted from the housing 11 through the opening 151, the waste liquid tank 60 is in an orientation, in which the direction of the shorter side of the waste liquid tank 60 coincides with the mounting/demounting direction. Therefore, a stroke for mounting or demounting is shorter than an orientation, in which the direction of the longer side of the waste liquid tank 60 coincides with the mounting/demounting direction, and the waste liquid tank 60 may be exchanged easily. Thus, while the strength of the housing 11 may be secured, the waste liquid tank 60 may be arranged in the orientation for easier exchange.

Moreover, as shown in FIG. 6, the waste liquid tank 60 is arranged at the position to partly overlap the feeder tray 21 in the view along the widthwise direction. Thus, while the space alongside the feeder tray 21 in the scanning direction may be used effectively, the length L1 of the waste liquid tank 60 in the conveying direction may be increased so that the capacity of the waste liquid tank 60 may be increased. Accordingly, the inkjet printer 1 may be downsized in the vertical direction, i.e., in the direction of height.

### SECOND EMBODIMENT

Next, an inkjet printer 1A according to a second embodiment of the present disclosure will be described with reference to FIG. 8. In the following paragraphs, items that are substantially identical to those described above will be referred to by the same reference signs, and description of those items is herein omitted.

FIG. 8 is a sideward view of the inkjet printer 1A viewed from left. As shown in FIG. 8, the inkjet printer 1A is different from the inkjet printer 1 described above in that a waste liquid tank 60A of the inkjet printer 1A has a form of reversed L, in the sideward view from the left, and a length LIA in the conveying direction is longer than the length L1 of the waste liquid tank 60 in the conveying direction.

In particular, the waste liquid tank 60A has a stepped form 61A. In an area above the stepped form 61A, the conveyer motor 108 is located. Similarly to the arrangement illustrated in FIG. 3, the mounting/demounting direction of the waste liquid tank 60A coincides with the widthwise direction; therefore, when the waste liquid tank 60A is mounted in or demounted from the housing 11, the conveyer motor 108 may not interfere with the waste liquid tank 60A. Accordingly, the area above the waste liquid tank 60A may be used efficiently.

According to the inkjet printer 1A in the second embodiment, the benefits achievable by the inkjet printer 1 in the first embodiment may be similarly achieved. In particular, in the arrangement such that the waste liquid tank 60A has the form of reversed L in the sideward view and the length LIA in the conveying direction is longer than the length L1 of the waste liquid tank 60 in the conveying direction, the capacity of the waste liquid tank 60A may be increased compared to the waste liquid tank 60 in the first embodiment.

### MORE EXAMPLES

While the invention has been described in conjunction with the example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

For example, the waste liquid tank 60, 60A may not necessarily be located on the leftward side in the housing 11 but may be located on the rightward side in the housing 11. For another example, the maintenance unit 8 may not necessarily be located on the rightward side of the platen 43 but may be located on the leftward side of the platen 43.

For another example, the liquid discharging apparatus may not necessarily be applied to the inkjet printer 1, 1A but may be applied to, for example, a multi-function peripheral (MFP) machine having multiple functions such as printing, scanning, copying, and facsimile transmission.

For another example, the inkjet printer 1, 1A may not necessarily be limited to the serial-styled inkjet printer, in which the inks L are discharged from the nozzles 42 while the carriage 40 is moved in the scanning direction, but may be, for example, a line-styled inkjet printer, in which the liquid discharging head 41 longitudinally extending throughout the width of the sheet P along the scanning direction stays immovably at a position within the housing 11.

For another example, the waste liquid tank 60, 60A may not necessarily be located below both of the conveyer roller 50 and the ejection roller 52 but may be located below one of the conveyer roller 50 and the ejection roller 52. For another example, the waste liquid tank 60, 60A may be located above the conveyer roller 50 and the ejection roller 52.

For another example, the waste liquid tank 60, 60A may not necessarily be located below both of the guide rails 91, 92 but may be located below one of the guide rails 91, 92. For another example, the waste liquid tank 60, 60A may be located above the guide rails 91, 92.

For another example, the waste liquid tank 60, 60A may not necessarily store the waste liquid discharged from the nozzles 42 during the maintenance process by the maintenance unit 8 or the flushing process by the flushing unit 70.

For example, the inkjet printer 1, 1A may not necessarily have the flushing unit 70, and the waste liquid tank 60, 60A may be located on the rightward side of the platen 43. For another example, the inkjet printer 1, 1A may not necessarily have the maintenance unit 8, or the waste liquid tank 60, 60A may not necessarily have the port 63. For another example, the waste liquid tank 60, 60A may store waste liquid that may be produced with use of other cleaning device than the maintenance unit 8 or the flushing unit 70.

What is claimed is:

1. A liquid discharging apparatus, comprising:
a housing;
a liquid discharging head including nozzles for discharging liquid;
a waste liquid tank demountably mounted in the housing through an opening formed on a sideward face of the housing on one side in a widthwise direction, the widthwise direction intersecting orthogonally with a conveying direction to convey a sheet in a conveyer path from a first side toward a second side, the waste liquid tank being configured to store waste liquid; and
a flushing unit configured to guide the liquid discharged from the liquid discharging head in a flushing process to the waste liquid tank,
wherein the waste liquid tank is mounted in the housing in an arrangement such that a length of the waste liquid tank in the widthwise direction is shorter than a length of the waste liquid tank in the conveying direction, the waste liquid tank being mountable in and demountable from the housing along the widthwise direction of the waste liquid tank, and
wherein the flushing unit is located to overlap the waste liquid tank in a direction intersecting orthogonally with the widthwise direction and the conveying direction.

2. The liquid discharging apparatus according to claim 1, further comprising a storage for storing sheets,
wherein the waste liquid tank is located at a position to at least partly overlap the storage in a view from the sideward face of the housing along the widthwise direction.

3. The liquid discharging apparatus according to claim 1, further comprising a reader located on an upper side in the housing, the reader being configured to read an image of an object, wherein
the reader is pivotable with respect to the housing on a hinge being a pivot axis; and
the hinge is located on the one side of the waste liquid tank toward the first side in the conveying direction.

4. The liquid discharging apparatus according to claim 1, further comprising:
a carriage, on which the liquid discharging head is mounted, the carriage being movable in a scanning direction, the scanning direction being the widthwise direction;
a guide rail extending along the scanning direction, the guide rail supporting the carriage;
a supporting frame extending in the direction intersecting orthogonally with the widthwise direction and the conveying direction, the supporting frame supporting the guide rail, the supporting frame being located between the conveyer path and the sideward face of the housing in the widthwise direction,
wherein the waste liquid tank and the guide rail are located at positions to at least partly overlap each other in a view from an upper side of the housing, and
wherein the waste liquid tank is located on an outer side with respect to the supporting frame in the widthwise direction.

5. The liquid discharging apparatus according to claim 1, further comprising:
a carriage, on which the liquid discharging head is mounted, the carriage being movable in a scanning direction within a movable range, the scanning direction being the widthwise direction; and
a guide rail extending along the scanning direction, the guide rail supporting the carriage,
wherein the waste liquid tank and the guide rail are located at positions to at least partly overlap each other in a view from an upper side of the housing, and
wherein, when the carriage is at an end of the movable range toward the sideward face of the housing in the widthwise direction, one end of the carriage toward the sideward face of the housing in the widthwise direction is located between one end of the waste liquid tank toward the sideward face in the widthwise direction and the other end of the waste liquid tank opposite to the one end in the widthwise direction.
